(19) United States
(12) Patent Application Publication
(10) Pub. No.: US 2011/0192900 A1
(43) Pub. Date: Aug. 11, 2011

(54) READING APPARATUS

(75) Inventors: Toshiyasu Terahara, Shizuoka (JP); Kaoru Matsuhisa, Shizuoka (JP); Yuuki Kawaguchi, Chiba (JP)

(73) Assignee: TOSHIBA TEC KABUSHIKI KAISHA, Tokyo (JP)

(21) Appl. No.: 13/020,049

(22) Filed: Feb. 3, 2011

(30) Foreign Application Priority Data
Feb. 5, 2010 (JP) 2010-024307
Feb. 5, 2010 (JP) 2010-024308

(51) Int. Cl. G06K 7/01; G06K 7/14

(52) U.S. Cl. 235/383; 235/470

(57) ABSTRACT

A reading apparatus according to an embodiment includes a placing part, a scanner, and a scanner holding part. The placing part has a placing surface on which an article is placed at the upper surface thereof. The scanner has a front wall provided with a reading window. The scanner reads article identification information positioned at a reading region in front of the reading window. The scanner holding part disposes the scanner above the placing surface. The reading apparatus has a space between the scanner and the placing part. The reading apparatus allows the article to be displaced on the placing part corresponding to a part below the scanner.

### CROSS-REFERENCE TO RELATED APPLICATIONS

This application is based upon and claims the benefit of priority from Japanese Patent Application No. 2010-024307 filed Feb. 5, 2010 and Japanese Patent Application No. 2010-024308 filed Feb. 5, 2010, the entire contents of which are incorporated herein by reference.

### FIELD

Embodiments are related to a reading apparatus.

### BACKGROUND

Typically, for example, there are self-checkout apparatuses which are installed in retail shops such as supermarkets to execute accountancy by an operation of a customer.

As such a self-checkout apparatus, there is known a self-checkout apparatus including a settlement terminal, a basket table, a measurer, and a bag supporting part (for example, see JP-A-2007-226498). The settlement terminal has a scanner that reads an article code. The basket table is disposed on one side of the settlement terminal. The measurer is disposed on the other side of the settlement terminal. The bag supporting part is provided on the measurer.

In the self-checkout apparatus, a customer as an operator places a shopping basket into which articles are put on the basket table before accountancy and supports a plastic bag with the bag supporting part. Then, the customer stands in front of the scanner and takes out the articles of the shopping basket by hand. Next, the customer brings the article close to the scanner so that the scanner reads an article code affixed to the article. In addition, the customer puts the article of which the article code is read by the scanner into the plastic bag supported by the bag supporting part. Thereafter, the self-checkout apparatus executes an accounting process on the articles of which the article codes are read by the scanner. The self-checkout apparatus has an advantage in that a shop assistant may not perform accounting works.

However, in the typical self-checkout apparatus, the bag supporting part is provided on the side of the scanner. Therefore, the customer has to move the article in the hand to the side of the scanner from the front of the scanner. Here, the customer has to move the article in the hand in a direction away from his or her body, so that there is a great burden on the customer.

### DESCRIPTION OF THE DRAWINGS

FIG. 1 is a perspective view of a self-checkout apparatus according to a first embodiment.

FIG. 2 is a front view of the self-checkout apparatus according to the first embodiment.

FIG. 3 is a plan view of the self-checkout apparatus according to the first embodiment.

FIG. 4 is a right side view of the self-checkout apparatus according to the first embodiment.

FIG. 5 is a left side view of the self-checkout apparatus according to the first embodiment.

FIG. 6 is a right side view of a bag supporting table according to the first embodiment.

FIG. 7 is a view showing an inside of a table part according to the first embodiment.

FIG. 8 is a perspective view showing a part of a bag supporting part according to the first embodiment.

FIG. 9 is a view showing a start screen according to the first embodiment.

FIG. 10 is a block diagram showing electrical connections of each part of the bag supporting table according to the first embodiment.

FIG. 11 is a block diagram showing a functional configuration of a CPU of the bag supporting table according to the first embodiment.

FIG. 12 is a flowchart showing a flow of an accounting process executed by the CPU of the bag supporting table according to the first embodiment.

FIG. 13 is a perspective view of a self-checkout apparatus according to a second embodiment.

### DETAILED DESCRIPTION

In a reading apparatus according to the embodiments, an operator can easily put an article of which article identification information is read by a scanner into a shopping basket.

The reading apparatus according to the embodiments has a placing part, a scanner, and a scanner holding part. The placing part has a placing surface on which an article is placed at the upper surface thereof. The scanner has a front wall provided with a reading window. The scanner reads the article identification information positioned at a reading region in front of the reading window. The scanner holding part disposes the scanner above the placing surface. The reading apparatus has a space between the scanner and the placing part. The reading apparatus is able to place the article on the placing part corresponding to a part below the scanner.

A reading apparatus according to an embodiment will now be described in detail with reference to the accompanying drawings. The embodiment described hereinbelow is an example in which a self-checkout apparatus is applied as the reading apparatus. In addition, the arrow a in the figure represents a vertical direction of the self-checkout apparatus. The arrow b in the figure represents a front and rear direction (depth direction) of the self-checkout apparatus. The arrow c in the figure represents a width direction (left and right direction) of the self-checkout apparatus.

### First Embodiment

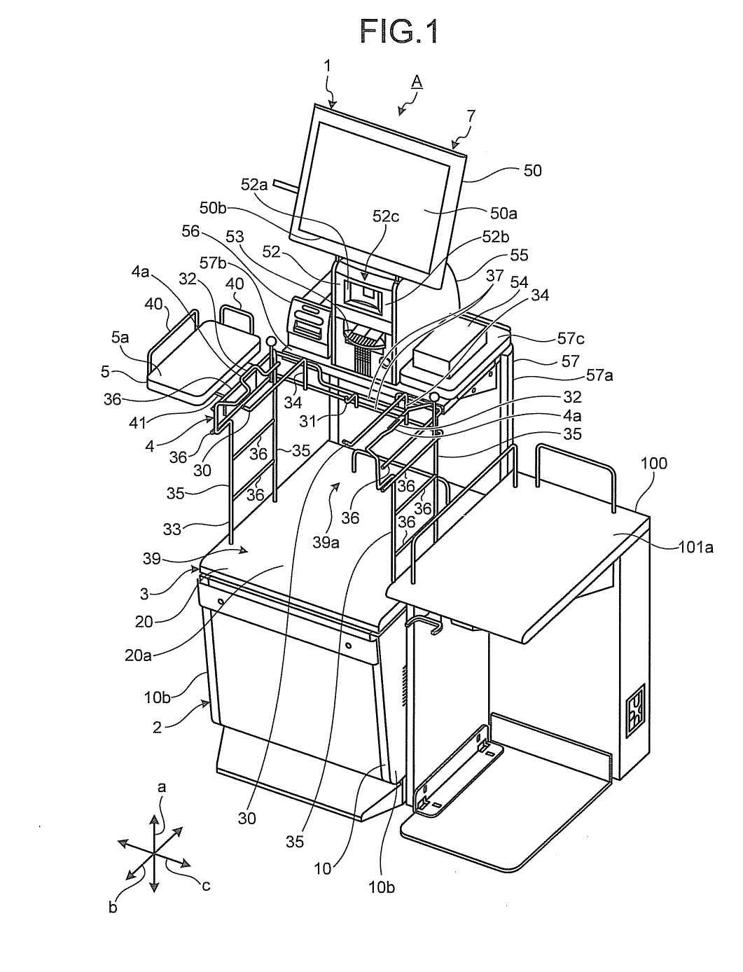

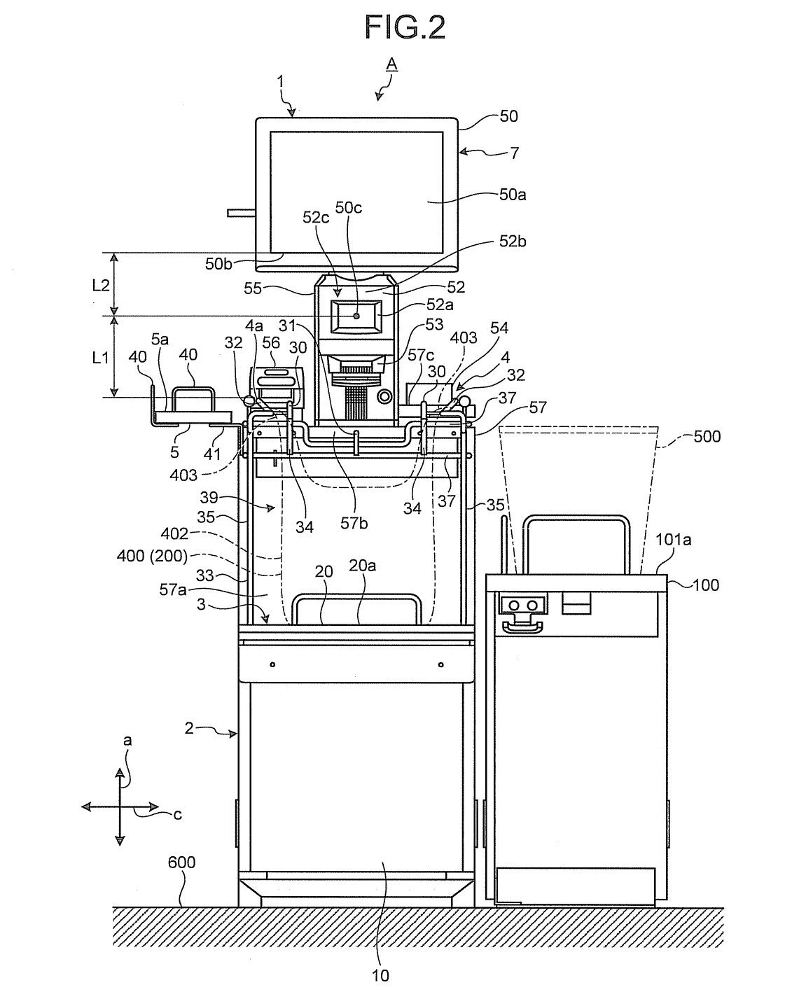

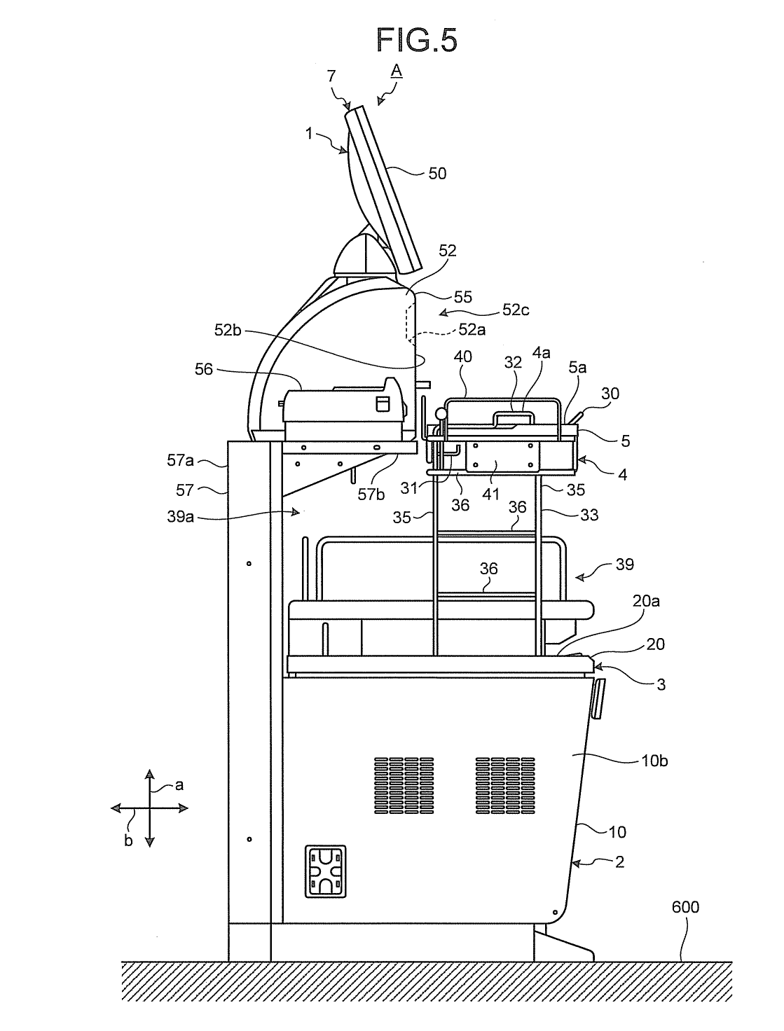

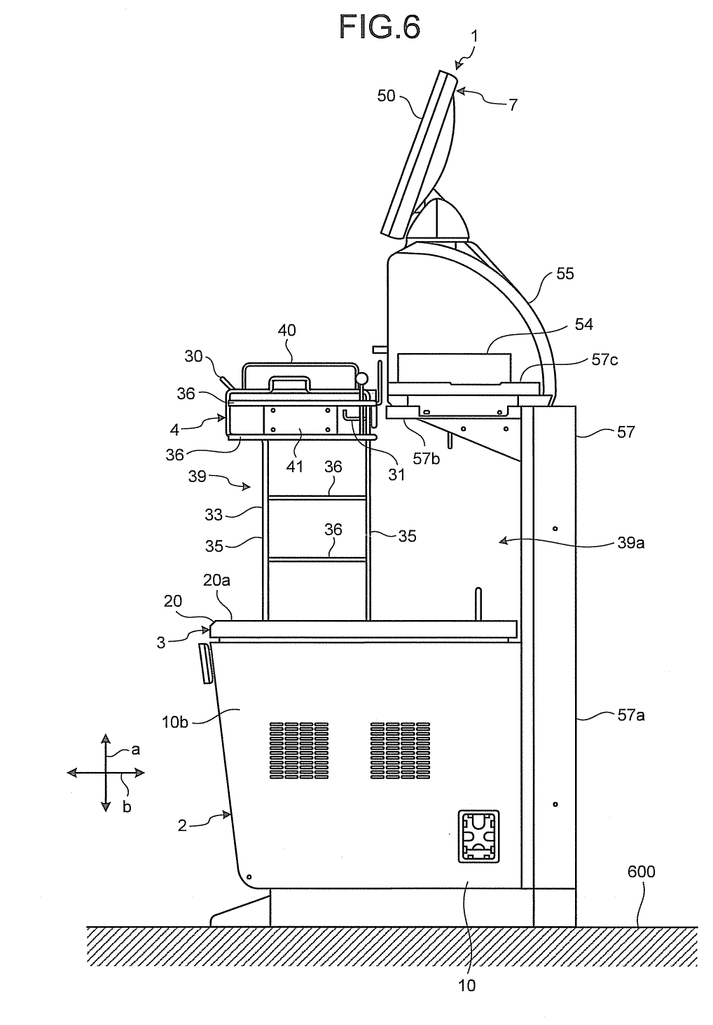

A first embodiment will be described with reference to FIGS. 1 to 12. As shown in FIGS. 1 to 5, a self-checkout apparatus A as the reading apparatus includes a bag supporting table 1 and a basket table 100 disposed on one side of the bag supporting table 1. The self-checkout apparatus A is installed on, for example, a floor surface 600 (FIG. 2) in a shop.

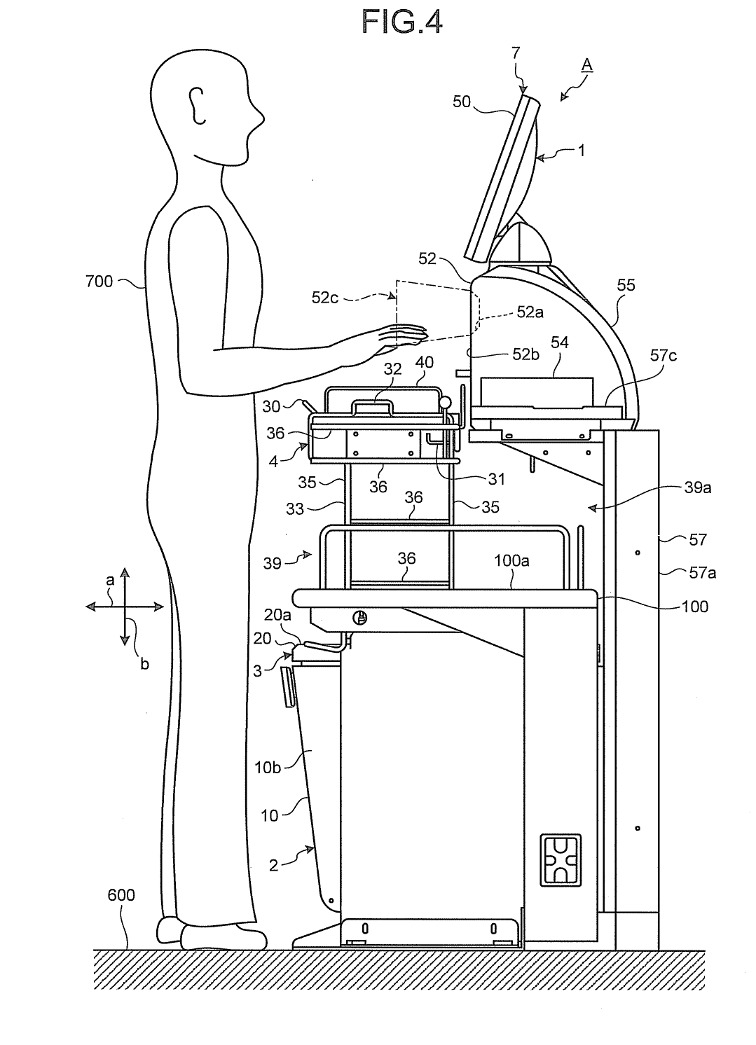

The bag supporting table 1 includes, as illustrated in FIGS. 1 to 6, a table part 2, a measurer 3, a bag supporting part 4, a temporal placing table 5, and a user interface terminal 7. The measurer 3 is provided at an upper part of the table part 2. The measurer 3 includes a placing part 20 with a substantially flat disk shape on which a shopping bag is placed. The bag supporting part 4 is provided on an upper surface of the placing part 20 of the measurer 3. The temporal placing table 5 is fixed to the placing part 20 and is disposed on a side of the placing part 20. The user interface terminal 7 has a scanner 52. The user interface terminal 7 is disposed above the measurer 3. The bag supporting table 1 is operated by an operator 700 (FIG. 4) in front (forward side) of the apparatus 1. The operator 700 is typically a customer, and a shop assistant may also be the operator 700.

The basket table 100 is disposed on the opposite side of the placing table 20 to the temporal placing table 5 in a plan view. A shopping basket 500 (FIG. 2) is placed on the basket table 100. With regard to the shopping basket 500, the shopping basket 500 (FIG. 2) in which articles, of which the article codes are not yet read by the scanner 52 are stored, is placed. Here, the article code is article identification information. The article code is affixed to an article in the form of a barcode.

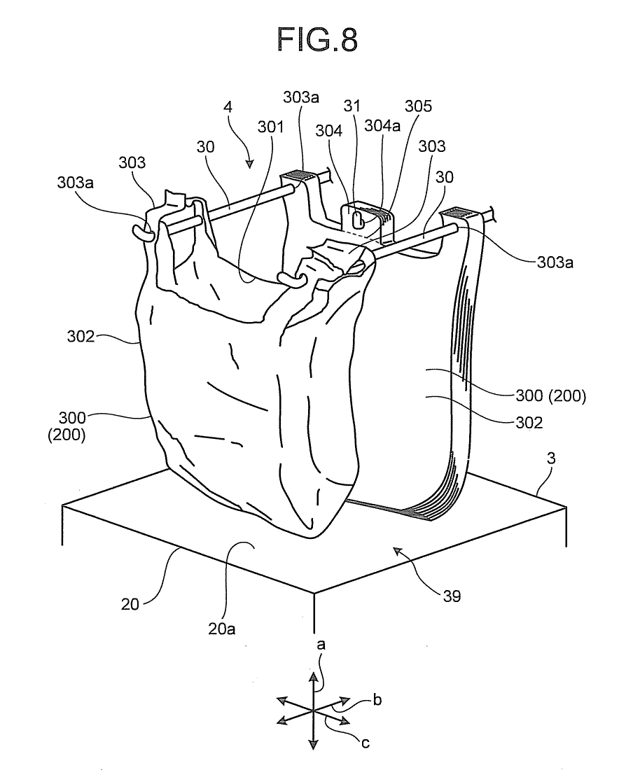

In the self-checkout apparatus A, the operator 700 places the shopping basket 500 into which articles before accountancy are put on the basket table 100, and causes a shopping bag 200 (see FIGS. 2 and 8) to be supported by the bag supporting part 4. In addition, the operator 700 stands in front of (forward from) the bag supporting table 1. In addition, the operator 700 takes out the article into the shopping basket 500 placed on the basket table 100 by hand. Next, the operator 700 brings the taken article close to the scanner 52 so that the article code affixed to the article is read by the scanner 52. In addition, the operator 700 fills the shopping bag 200 supported by the bag supporting part 4 in an opened state with the article of which the article code is read by the scanner 52. Thereafter, the bag supporting table 1 executes a payment process for the articles of which the article codes are read by the scanner 52.

Each part of the bag supporting table 1 will now be described in detail.

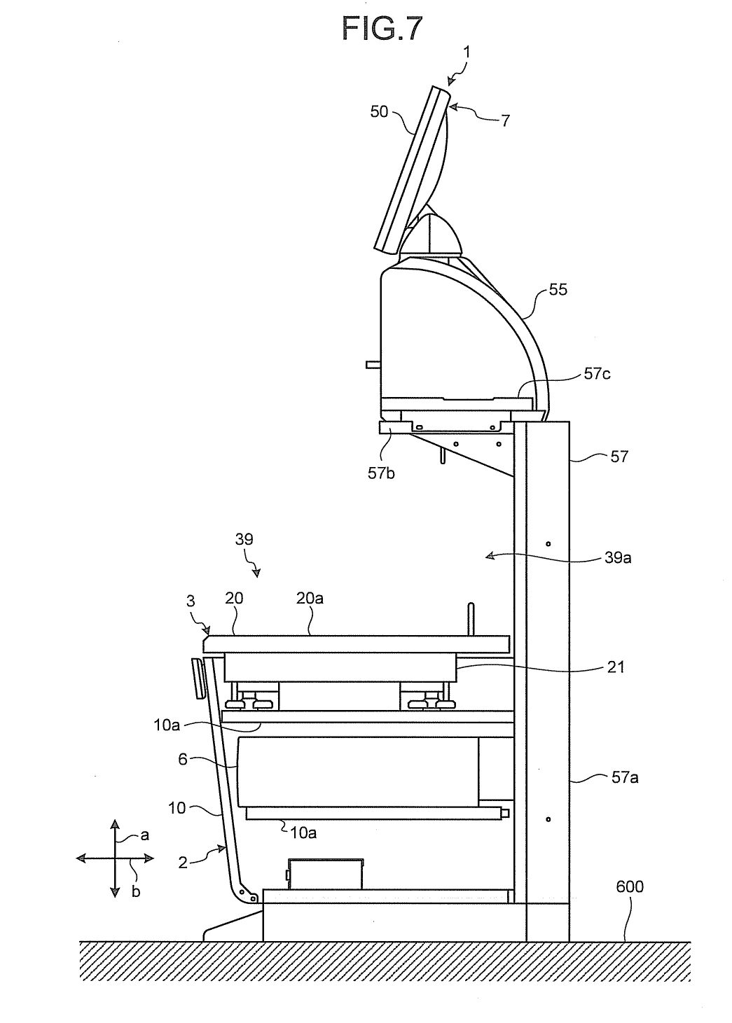

The table part 2 has a first housing 10 and the placing part 20. The first housing 10 is formed in a rectangular box shape with an opening at the upper side. The placing part 20 is disposed at the upper side of the first housing 10. The placing part 20 is movable upward and downward with respect to the first housing 10. The placing part 20 covers the upper side opening of the first housing 10. Inside the first housing 10, as illustrated in FIG. 7, upper and lower shelves 10a in two levels are provided. The shelves 10a are suspended on and fixed to a pair of left and right side walls 10b. The measurer 3 is placed on the upper shelf 10a, and an information processing device 6 is placed on the lower shelf 10a.

The information processing device 6 is disposed below the measurer 3 inside the table part 2. Specifically, the information processing device 6 is disposed immediately below the measurer 3. The information processing device 6 is a computer having a control unit 8 (see FIG. 10) that controls each part of the bag supporting table 1. The information processing device 6 functions as a POS (Point of Sales) terminal.

The measurer 3 includes, as illustrated in FIG. 7, the placing part 20 and a measuring part 21. The placing part 20 is formed integrally with the bag supporting part 4 as illustrated in FIGS. 1 to 6. The placing part 20 receives a load of the shopping bag 200 (FIGS. 2 and 8) supported by the bag supporting part 4. Specifically, an upper surface of the placing part 20 is formed to be almost flat. The upper surface of the placing part 20 has a placing surface 20a on which the shopping bag 200 is placed. In addition, articles are placed on the placing surface 20a. The placing surface 20a supports a bottom portion of the shopping bag 200. In addition, although not particularly shown, the operator 700 may place a basket brought to the shop by him or her on the placing surface 20a. In this case, the placing surface 20a supports a bottom portion of the basket. The measuring part 21 is positioned under the placing part 20. The measuring part 21 is connected to the placing part 20. The measuring part 21 measures the load exerted on the placing part 20 and outputs the measured load to the control unit 8 as an electrical signal. The measuring part 21 includes, for example, load cells and the like.

The bag supporting part 4 supports the shopping bag 200 placed on the placing surface 20a in the opened state. Specifically, the bag supporting part 4 is pierced through handles of the shopping bag 200 having a pair of handles so as to support the shopping bag 200 in the opened state. The bag supporting part 4 is disposed in front of a reading window 52a of the scanner 52 (in front of the reading window 52a of the scanner 52 as viewed from the operator 700) and below the reading window 52a (see FIGS. 1 and 2). In addition, the bag supporting part 4 is disposed at the side of the basket table 100.

Here, the shopping bag 200 is a bag in which articles of which article codes are read by the scanner 52 are stored. In this embodiment, as the shopping bag 200, a plastic bag 300 (FIG. 8) or a bag 400 (FIG. 2) is applied. The plastic bag 300 is a shopping bag provided by a shop for the operator 700. The bag 400 is a shopping bag brought by the operator 700 to the shop. Specifically, the plastic bag 300 has, as illustrated in FIG. 8, a storage part 302, a pair of handles 303, and a pair of hook pieces 304. The storage part 302 is provided with an opening 301 at the upper side thereof. The pair of handles 303 extends from upper portions of the storage part 302. The pair of hook pieces 304 is positioned between the pair of handles 303. The pair of handles 303 is provided with through-holes 303a. In addition, each hook piece 304 is provided with a hook hole 304a. A portion of the hook piece 304 which is connected to the storage part 302 is provided with perforations 305. The hook piece 304 is able to be separated from the storage part 302 along the perforations 305. The bag 400 has, as illustrated in FIG. 2, a storage part 402 and a pair of handles 403. The storage part 402 is provided with an opening at the upper side. The pair of handles 403 extends from upper portions of the storage part 402. In addition, hereinafter, when the plastic bag 300 and the bag 400 are not particularly distinguished in the description, they are simply called the shopping bag 200.

The bag supporting part 4 has a pair of left and right first hook parts 30, a hook 31, and a pair of left and right second hook parts 32. The pair of left and right first hook parts 30 are separated in the horizontal direction and opposed to each other. The pair of left and right first hook parts 30 supports the plastic bag 300 in the opened state. The pair of left and right second hook parts 32 are separated in the horizontal direction and opposed to each other. The pair of left and right second hook parts 32 supports the bag 400 in the opened state. That is, the bag supporting part 4 has, as a pair of supporting parts, the pair of first hook parts 30 and the pair of second hook parts 32. In the bag supporting part 4, a supporting structure 33 fixes the first hook parts 30, the hook 31, and the second hook parts 32 to the placing part 20. Here, the placing surface 20a of the placing part 20 is adopted as a part of the bag supporting part 4.

The supporting structure 33 has first struts 34, second struts 35, first beam materials 36, and second beam materials 37. The first struts 34 support the first hook part 30. The second struts 35 support the second hook part 32. The first and second beam materials 36 and 37 are caught between the first and second struts 34 and 35.

The two second struts 35 are set up from each of both border portions of the placing part 20 in the width direction. That is, a total of four second struts 35 are provided. The second struts 35 at each border portion of the placing part 20 are disposed at an interval along the front and rear direction. In addition, the second struts 35 opposed to each other in the front and rear direction of the placing part 20 are connected with a plurality of the first beam materials 36. In addition, the second struts 35 positioned on the rear side from among the four second struts 35 are connected with the second beam materials 37. In addition, the first strut 34 is fixed to the second beam material 37.

An interval between the second struts 35 positioned on the forward side of the supporting structure 33 is open. In thus structure, the operator 700 can take the shopping bag 200 in and out of the forward side of the placing part 20 with respect to the placing surface 20a. In addition, the second beam material 37 is disposed above the placing surface 20a. The second beam material 37 is separated from the placing surface 20a.

The first hook part 30 is constructed as an arm member in a bar shape. The arm member extends forward from an upper end portion of the first strut 34. The first hook part 30 is cantilevered on the first strut 34 to be supported. The first hook part 30 is positioned above the placing surface 20a. As illustrated in FIG. 8, the pair of first hook parts 30 is inserted into the handles 303 of the plastic bag 300 so as to be pierced through the handles 303 of the plastic bag 300 and support the plastic bag 300 in the opened state. The one first hook part 30 is pierced through the one handle 303 of the plastic bag 300. The other first hook part 30 is pierced through the other handle 303 of the plastic bag 300. The first hook part 30 is formed by bending a single bar member made of metal and is formed integrally with the first strut 34.

The hook 31 is disposed between the pair of first hook parts 30 as illustrated in FIGS. 1 and 8. The hook 31 protrudes forward from the second beam member 37. The hook 31 is positioned above the placing surface 20a. The hook 31 is pierced through the hook hole 304a of the hook piece 304 of the plastic bag 300 so as to be suspended.

The hook 31 and the first hook part 30 suspend and support the plastic bags 300 in a folded state hung thereon. In this state, when articles are filled in the plastic bag 300, the operator 700 removes the hook piece 304 from the plastic bag 300. Subsequently, the operator 700 pulls the plastic bag 300 forward to be in the opened state. The plastic bag 300 in the opened state is supported by the pair of first hook parts 30 while being pierced thereby. That is, in this embodiment, the pair of first hook parts 30 can support the plastic bag 300 in either of the opened or closed states. As such, the bottom portion of the plastic bag 300 supported by the first hook part 30 is supported by the placing part 20.

The second hook part 32 is formed in a hook shape. The second hook part 32 is connected to the second strut 35. The second hook part 32 is fixed to the placing part 20 through the second strut 35. Specifically, the second hook part 32 on the right is connected to the two second struts 35 on the right. The second hook part 32 on the left is connected to the two second struts 35 on the left. The pair of second hook parts 32 is positioned above the placing surface 20a. The second hook part 32 is formed by bending a single bar member made of metal and is formed integrally with the second strut 35. The pair of second hook parts 32 is pierced through the handles 403 of the bag 400 and supports the bag 400 in the opened state. The one second hook part 32 is pierced through the one handle 403 of the bag 400. The other second hook part 32 is pierced through the other handle 403 of the bag 400. The bottom portion of the bag 400 supported by the pair of second hook parts 32 as described above is supported by the placing surface 20a.

A space where the plastic bag 300 supported by the pair of first hook parts 30 in the opened state is disposed, and a space where the bag 400 supported by the pair of the second hook parts 32 in the opened state is disposed are collectively called a disposition space 39. The disposition space 39 includes a space above the placing surface 20a. In other words, the pair of first hook parts 30 and the second hook parts 32 dispose the shopping bag 200 in the disposition space 39. The pair of the first hook parts 30 is disposed between the pair of the second hook parts 32. The space where the plastic bag 300 is disposed by the pair of the first hook part 30 is called a first disposition space. The space where the bag 400 is disposed by the pair of the second hook part 32 is called a second disposition space. The first and second disposition spaces are at least partially the same. Here, a part of the placing part 20 which is provided with the bag supporting part 4 is disposed in front of the scanner 52. Between the scanner 52 and the spacing part 20, a space 39a which is able to accept a part of the shopping bag 200 is formed.

The bag supporting part 4 having the above configuration is fixed to the placing part 20 as described above. Therefore, the placing part 20 supports the bag supporting part 4. The placing part 20 receives the load of the shopping bag 200 supported by the bag supporting part 4.

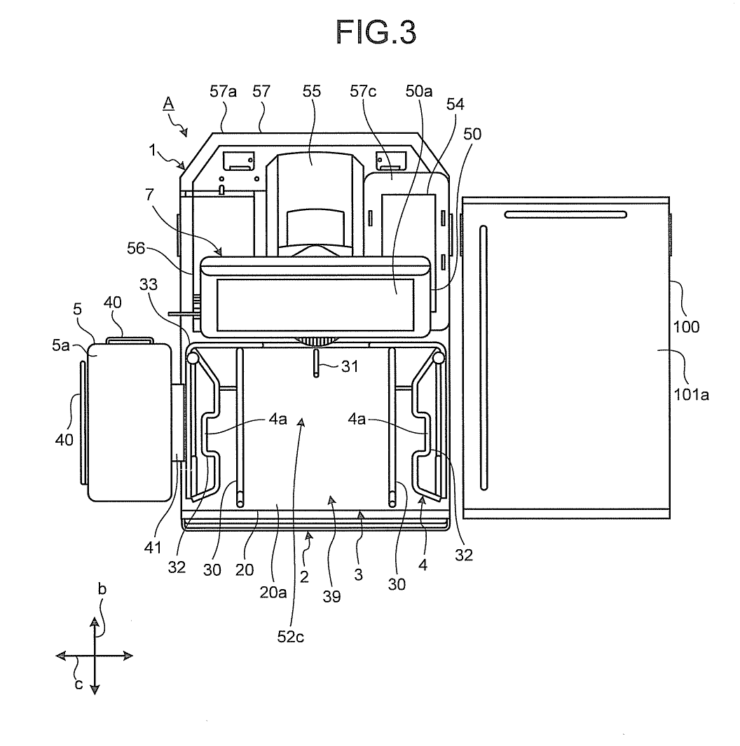

The temporal placing table 5 is a table on which articles are temporarily placed. The temporal placing table 5 is a member separate from the bag supporting part 4. The temporal placing table 5 is disposed in front of the scanner 52 and on the side of the scanner 52 (see FIGS. 1 and 2). In addition, the temporal placing table 5 is disposed below the scanner 52 (see FIGS. 1 and 2). The temporal placing table 5 is disposed at a position spaced from the placing part 20 in the plan view (see FIG. 3). The temporal placing table 5 has a placing surface 5a of which the upper surface is almost flat. On the placing surface 5a, an article of which the article code is read by the scanner 52 and which is not stored in the shopping bag 200 yet is temporarily placed. The temporal placing table 5 is provided with a fall preventing member 40. The fall preventing member 40 is in contact with the article placed on the placing surface 5a to prevent the article from falling down from the temporal placing table 5. The temporal placing table 5 is fixed to the bag supporting part 4. Specifically, the temporal placing table 5 is fixed to the supporting structure 33 of the bag supporting part 4 through the supporting member 41. Therefore, the placing part 20 supports the temporal placing part 5 through the supporting member 41 and the bag supporting part 4. Therefore, the placing part 20 receives the load of the article placed on the temporal placing table 5.

The user interface terminal 7 has, as illustrated in FIG. 1, a display 50, a scanner 52, and a printer 53. The scanner 52 is disposed below the display 50. The printer 53 is disposed below the scanner 52. A touch panel 51 (FIG. 10) is stacked on a display screen 50a of the display 50. The display 50, the scanner 52, and the printer 53 are provided integrally with a second housing 55. That is, the second housing 55 is a housing of each of the display 50, the scanner 52, and the printer 53.

The user interface terminal 7 is supported by a supporting member 57. The supporting member 57 has a column member 57a and a supporting plate 57b. The column member 57a extends upward from the rear portion of the table part 2. The supporting plate 57b extends forward from an upper end portion of the column member 57a. The column member 57a is fixed to the table part 2. The user interface terminal 7 is placed on an upper surface of the supporting plate 57b. A supporting table 57c is stacked on one side part of the supporting plate 57b. A settlement device 54 is placed on the supporting table 57c. In addition, a card reader and writer 56 is placed on the other side part of the supporting plate 57b.

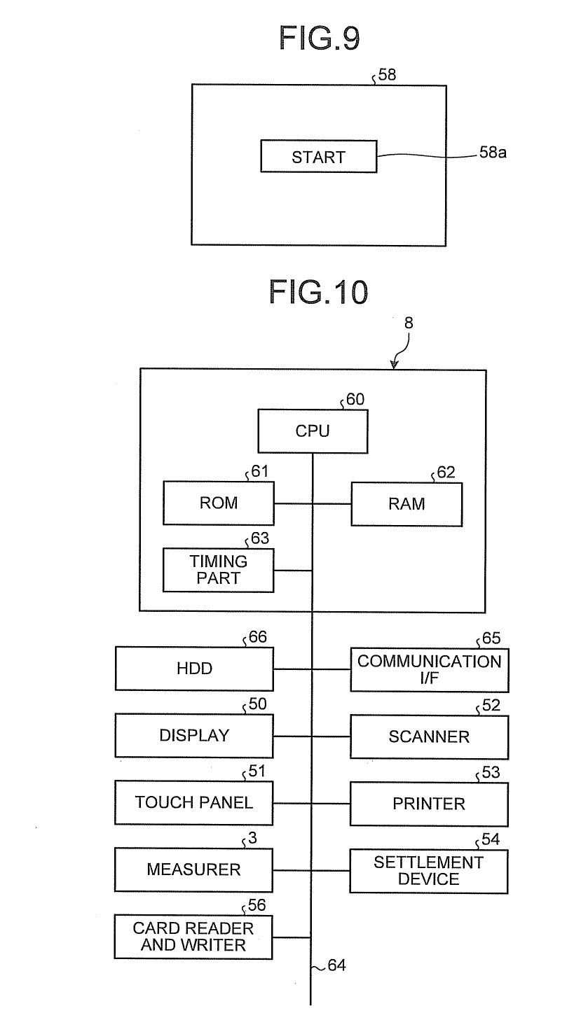

The display 50 has the display screen 50a. The display screen 50a is disposed above the bag supporting part 4. The display 50 is, for example, a liquid crystal display. The display 50 is controlled by the control unit 8 and displays information on the display screen 50a. The display 50 displays, for example, a start screen 58 shown in FIG. 9. The start screen 58 displays a start button 58a.

The touch panel 51 recognizes a position as XY coordinates on the panel touched by the operator 700 and acquires coordinate data. The touch panel 51 inputs a signal corresponding to the acquired coordinate data to the control unit 8. The control unit 8 recognizes a button or the like displayed on the display 50 corresponding to the coordinates designated by the touch panel 51 which is touched to operate. The touch panel 51 functions as an announcement part. The touch panel 51 announces the start of a measurement of an article as the start button 58a of the start screen 58 is touched.

The scanner 52 has a front wall 52b. The front wall 52b constitutes a front wall of the second housing 55. The front wall 52b is provided with the reading window 52a facing the operator 700. The scanner 52 is disposed above the placing surface 20a (the placing surface 20a) by the supporting member 57 as a scanner holding part (see FIGS. 1, 2, and 5). Accordingly, a space 39a is provided between the scanner 52 and the placing part 20. In addition, it becomes possible to place an article on the placing part 20 corresponding to a part below the scanner 52. The scanner, in other words, 52 overlaps with the placing surface 20a at a part above the placing surface 20a in the vertical direction through a space (acceptance space) 39a which is able to accept a part of the shopping bag. With regard to the scanner 52, a front side of the reading window 52a becomes a reading region (indicated by a virtual line of FIG. 4) 52c, and the reading region 52c is positioned immediately above the placing surface 20a. In addition, in the front view, the reading window 52a is interposed between the pair of hook parts (the pair of the first hook parts 30 or the pair of the second hook parts 32) of the shopping bag 200 (see FIG. 2). In other words, the reading window 52a is interposed between the pair of hook parts (the pair of the first hook parts 30 or the pair of the second hook parts 32) of the shopping bag 200 in the direction (the same direction as the arrow c) in which the pair of hook parts of the shopping bag 200 (the pair of the first hook parts 30 or the pair of the second hook parts 32) oppose to each other. The scanner 52 optically reads an article code which is an article identification information affixed to an article positioned in front of the reading window 52a (the forward side of the reading window 52a as viewed from the operator 700). Specifically, the scanner 52 reads the article identification information affixed to the article and positioned at the reading region 52c. That is, the scanner 52 reads the article identification information positioned at the reading region 52c in front of the reading window 52a. The scanner 52 inputs the read information to the control unit 8.

The reading window 52a is disposed on the rear side of the bag supporting part 4 (on the inside of the bag supporting part 4 as viewed from the operator 700) and above the bag supporting part 4 (see FIGS. 1, 2, and 4). In addition, as illustrated in FIG. 2, a central portion 52c of the reading window 52a in the vertical direction is disposed on a side closer to a lowermost end 50b of the display screen 50a from among an uppermost end 4a of the bag supporting part 4 and the lowermost end 50b of the display screen 50a of the display 50 (see FIG. 2). A distance L2 from the central portion 52c of the reading window 52a to the lowermost end 50b of the display screen 50a is shorter than a distance L1 from the central portion 52c of the reading window 52a to the uppermost end 4a of the bag supporting part 4. Here, in this embodiment, an uppermost end of the second hook part 32 is the uppermost end 4a of the bag supporting part 4. In addition, the uppermost end 4a of the bag supporting part 4 is not limited to the uppermost end of the second hook part 32, and an uppermost end of the first hook part 30 may be the uppermost end 4a of the bag supporting part 4. In addition, both the uppermost ends of the first and second hook parts 30 and 32 maybe the uppermost end 4a of the bag supporting part 4. In addition, the middle position of the pair of hook parts in the opposed direction of the pair of hook parts (the pair of the first hook parts 30 or the pair of the second hook parts 32), the central portion of the display screen 50a in the opposed direction of the pair of hook parts, and the central portion of the reading window 52a in the opposed direction of the pair of hook parts are aligned on one straight line in the front view (in other words, in the vertical direction).

The printer 53 prints necessary items for a receipt on a receipt sheet which is a long sheet of paper (not shown). In addition, the printer 53 cuts the part on which the necessary items are printed from the receipt sheet to be issued as a receipt.

In addition, the bag supporting table 1 has the settlement device 54. The settlement device 54 is installed on the supporting table 57c. The supporting table 57c is installed to be disposed on the side of the second housing 55 as described above. The settlement device 54 executes near field radio communication with a non-contacting IC (not shown) card covered by the scanner. The settlement device 54 reads information associated with a settlement and stored in the non-contacting IC card through near field radio communications. The settlement device 54 executes radio communication with the non-contacting IC card using radio waves for near field radio communication used for, for example, RFID (Radio Frequency Identification). Here, the non-contacting IC card stores, as the information associated with the settlement, information such as the balance of pre-paid electronic money, card identification information, and customer identification information.

In addition, the bag supporting table 1 has a card reader and writer 56. The card reader and writer 56 reads and writes data on a magnetic card such as a membership card.

As shown in FIG. 10, the control unit 8 has a CPU (Central Processing Unit) 60, a ROM (Read Only Memory) 61, a RAM (Random Access Memory) 62, and a timing part 63. The CPU 60 controls each part centrally. The ROM 61 stores fixed data such as a boot program in advance. The RAM 62 forms various buffers such as a sales buffer or a print buffer and rewritably stores various pieces of data. The timing part 63 times date and time. The ROM 61, the RAM 62, and the timing part 63 are connected to the CPU 60 via bus lines 64. The bus lines 64 include address buses, data buses, and the like. The RAM 62 forms an initial value storage area. The initial value storage area stores an initially measured value of the measurer 3.

The display 50, the touch panel 51, the measurer 3, the scanner 52, the printer 53, the settlement device 54, the card reader and writer 56, a communication interface (I/F in the figure) 65, and an HDD (Hard Disk Drive) 66 are connected with the bus lines 64 connected to the CPU 60. The HDD 66 is a storage unit. The communication interface 65 executes communications with an external apparatus.

The HDD 66 includes a hard disk. The HDD 66 stores programs for operating the control unit 8, article master files, sales files (all not shown), and the like. The article master file is a file storing article name, price, weight, and the like of a corresponding article code. The sales file is a file storing sales data and the like. The program stored in the HDD 66 is written in the RAM 62 along with various files such as the article master file. Accordingly, each part can be controlled and driven by the control unit 8.

Although described later in detail, the control unit 8 reads out the weight of the article of which the article code is read by the scanner 52 from the HDD 66. The control unit 8 determines whether or not an article which is not read by the scanner 52 yet is placed on the placing part 20 using the read-out weight and the load measured by the measurer 3.

A method of using the bag supporting table 1 having the above structure will be described in detail. The operator 700 places the shopping basket 500 in which articles before accountancy are put on the basket table 100. The operator 700 supports the shopping bag 200 (the plastic bag 300 or the bag 400) with the bag supporting part 4 in the opened state. In addition, the operator 700 stands in front of the bag supporting table 1 and touches the start button 58a of the start screen 58 displayed on the display 50. Thereafter, the operator 700 takes out the article of the shopping bag 500 placed on the basket table 100 by hand. The operator 700 brings the taken article close to the scanner 52 so that the scanner 52 reads an article code affixed to the article. In addition, the operator 700 fills the shopping bag 200 supported by the bag supporting part 4 in the opened state with the article of which the article code is read by the scanner 52. Here, in this embodiment, since the bag supporting part 4 is disposed in front of the reading window 52a and below the reading window 52a, the shopping bag 200 supported by the bag supporting part 4 is positioned in front of the reading window 52a and below the reading window 52a. Therefore, the operator 700 causes the article code to be read by the scanner 52 and moves the article in the hand downward to put the article into the shopping bag 200. In addition, the operator 700 moves the article in the hand in front of the scanner 52 and then moves the article downward, thereby putting the article in the shopping bag 200. That is, at this time, the operator 700 may not move the article in the hand in a direction away from his or her body. Here, after the start button 58a is touched, the display 50 displays a screen displaying an end button.

At this time, the operator 700 may use the temporal placing table 5. For example, the operator 700 causes the article code to be read by the scanner 52 and then places the article, which is likely to be crushed, such as bread, on the temporal placing table 5. In addition, the operator 700 fills the shopping bag 200 with another article. Thereafter, the operator 700 may put the article down from the temporal placing table 5 so as to be put into the shopping bag 200.

When the operator 700 ends filling the shopping bag 200 with the articles, the operator 700 touches the end button displayed on the display 50. In addition, the operator 700 covers the settlement device 54 with the non-contacting IC card to pay for the articles by, for example, electronic money. Thereafter, the operator 700 detaches the shopping bag 200 from the bag supporting part 4 so as to detach the shopping bag 200 from the bag supporting table 1.

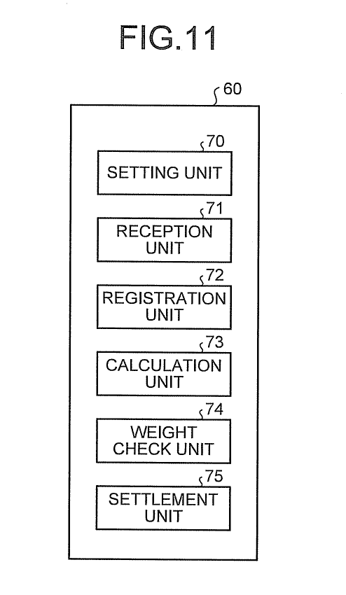

Next, an accounting process executed by the CPU 60 of the bag supporting table 1 when the bag supporting table 1 is used in the above using method will be described. In the accounting process, according to programs, as shown in FIG. 11, the CPU 60 realizes a setting unit 70, a reception unit 71, a registration unit 72, a calculation unit 73, a weight check unit 74, and a settlement unit 75 as functional units. The setting unit 70 functions as a setting part. The reception unit 71 functions as a reception part. The registration unit 72 functions as a display drive part and a registration part. The calculation unit 73 functions as a calculation part. The weight check unit 74 functions as a weight check part. The settlement unit 75 functions as a settlement part.

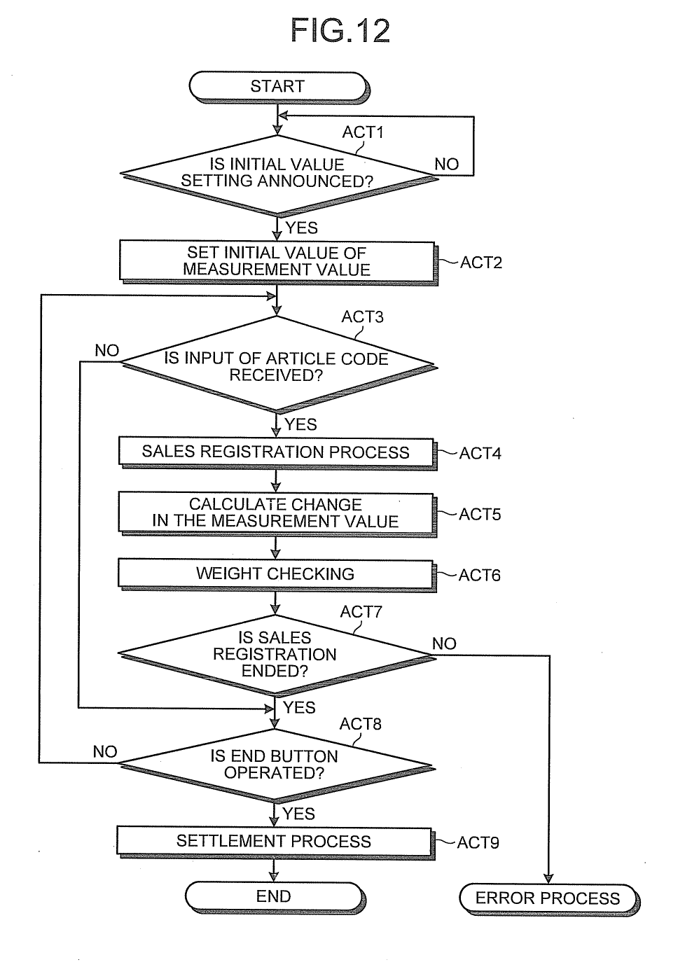

Next, a flow of the accounting process will be described with reference to the flowchart shown in FIG. 12. As shown in FIG. 12, the CPU 60 waits for the touch panel 51 to announce the start of a measurement of an article by touching the start button 58a of the start screen 58 (No in Act 1).

When the CPU 60 determines that the start of the measurement of the article is announced (Yes in Act 1), the CPU 60 operates as the setting unit 70 and sets a measurement value measured by the measurer 3 when the start of the measurement of the article is announced as an initial value (Act 2). Specifically, the CPU 60 stores the measurement value of the measurer 3 when the announcement of the start of the measurement of the article is determined on the basis of a signal received from the touch panel 51, in the initial value storage area of the RAM 62. Accordingly, the CPU 60 sets the measurement value as the initial value. In addition, the CPU 60 allows the scanner 52 to start a reading operation of an article code. In addition, the CPU 60 displays the screen displaying the end button on the display 50.

Next, the CPU 60 waits for the article code to be input by the scanner 52 (No in Act 3 and No in Act 8). The CPU 60 operates as the reception unit 71, and when the CPU 60 receives an input of the article code from the scanner 52 (Yes in Act 3), the CPU 60 operates as the registration unit 72 and executes a sales registration process of the article of which the article code is input (Act 4). Specifically, the CPU 60 searches the article master files and acquires article information such as article name, price, and weight corresponding to the input article code. The CPU 60 writes sales data of the corresponding article on the basis of the acquired article information. The CPU 60 stores the written sales data in the storage unit such as the RAM 62 to execute the sales registration of the article. In addition, the CPU 60 displays the name, price, or the like from the article information about the article on the display screen 50a of the display 50. Here, the article information may be displayed anywhere in the display screen 50a and is preferably displayed at a lower part of the display screen 50a. Moreover, the CPU 60 calculates the total amount of the sales registered articles up to now. The CPU 60 stores the calculated total amount in the storage unit such as the RAM 62. In addition, the CPU 60 displays the calculated total amount on the display 50.

Next, the CPU 60 operates as the calculation unit 73 and calculates a changed value of the measurement value by the measurer 3 from the initial value stored in the initial value storage area of the RAM 62 (Act 5). Specifically, the CPU 60 reads the article code in Act 3, and after a measurement value of the measurer 3 is increased as an article is placed on the placing part 20, the measurement value of the measurer 3 becomes stabilized to an almost constant value and then used as an object measurement value. In addition, the CPU 60 subtracts the initial value stored in the initial value storage area of the RAM 62 from the object measurement value, thereby calculating the changed value. Thereafter, the changed value is called an actual weight.

Next, the CPU 60 operates as the weight check unit 74 and executes weight checking (Act 6). Specifically, the CPU 60 determines whether or not the actual weight calculated in Act 5 has identity with the weight (hereinafter, called a theoretical weight) of the article searched in Act 4 and stored in the RAM 62. On the basis of this determination, the CPU 60 determines whether or not the article measured by the measurer 3 is registered as a sale in Act 4. That is, the CPU 60 determines whether or not an article which is not read by the scanner 52 is placed on the placing part 20. The CPU 60 determines that the actual weight and the theoretical weight have identity if a difference between the actual weight and the theoretical weight is in a prescribed range. In this case, the CPU 60 determines that the article measured by the measurer 3 finishes the sales registration. That is, the CPU 60 determines that the article which is not read by the scanner 52 is not placed on the placing part 20. On the other hand, if the difference between the actual weight and the theoretical weight is not in the prescribed range, the CPU 60 determines that the actual weight and the theoretical weight do not have identity. In this case, the CPU 60 determines that the article measured by the measurer 3 does not undergo the sales registration. That is, the CPU 60 determines that the article which is not read by the scanner 52 is placed on the placing part 20. After the determination process, the CPU 60 updates the value of the initial value storage area of the RAM 62 to the object measurement value obtained in Act 3 and sets the object measurement value as a new initial value.

If the CPU 60 determines that the article measured by the measurer 3 finishes the sales registration (Yes in Act 7), the end button is not touched (No in Act 8), and when there is an input of an article code, Act 3 is performed. In addition, the CPU 60 accepts the input of the article code and repeatedly performs Acts 3 to 7. On the other hand, if the CPU 60 determines that there is an article which is measured by the measurer 3 and does not undergo the sales registration (No in Act 7), a prescribed error process is executed.

In addition, if the CPU 60 determines that the end button displayed on the display 50 is touched (Yes in Act 8), the CPU 60 operates as the settlement unit 75 and executes a settlement process (Act 9). At the settlement process, the CPU 60 calculates the price of the sales registered articles. The CPU 60 displays the calculated price on the display 50. In addition, the CPU 60 drives the settlement device 54 and allows the settlement device 54 to execute a settlement with a non-contacting IC card covered by the settlement device 54. The settlement device 54 reads the balance of electronic money stored in the non-contacting IC card and information such as card identification information. Thereafter, the settlement device 54 reduces the amount of the price from the balance of the electronic money using the non-contacting IC card. In addition, the CPU 60 issues a receipt for the transaction using the printer 53. In addition, the CPU 60 generates billing information. The billing information is information for connecting the card identification information read by the settlement device 54 to the amount of the price of the articles. The billing information is transmitted to a server at a predetermined timing to an electronic money management company. In addition, cash corresponding to the amount of the price included in the billing information is paid into a bank account designated by the shop from the electronic money management company by a process of the server.

As described above, in this embodiment, the bag supporting part 4 is disposed in front of the reading window 52a and below the reading window 52a. Therefore, the shopping bag 200 supported by the bag supporting part 4 is positioned in front of the reading window 52a (on the forward side of the reading window 52a as viewed from the operator 700) and below the reading window 52a. Therefore, the operator 700 causes the scanner 52 to read the article code and moves the article in the hand downward to put the article into the shopping bag 200. In addition, the operator 700 moves the article in the hand to the front of the scanner 52 and moves the article downward to put the article in the shopping bag 200. Therefore, here, the operator 700 may not move the article in the hand in a direction away from his or her body. Therefore, the operator 700 can easily put the article of which the article code is read by the scanner 52 into the shopping bag 200.

In addition, the bag supporting table 1 according to this embodiment has the measurer 3 having the placing part 20 and measuring a load exerted on the placing part 20. The bag supporting part 4 is provided integrally with the placing part 20. The placing part 20 receives the load of the shopping bag 200 supported by the bag supporting part 4. Therefore, the measurer 3 measures the load exerted on the placing part 20 including the weight of the shopping bag 200 supported by the bag supporting part 4.

In addition, in this embodiment, the information processing device 6 reads out the weight of the article of which the article code is read by the scanner 52 from the HDD 66 which is the storage unit storing the weights of articles. The information processing device 6 determines whether or not the article which is not read by the scanner 52 is placed on the placing part 20 using the read-out weight and the load measured by the measurer 3. Therefore, according to this embodiment, it is possible to suppress the article of which the article code is not read by the scanner 52 from being put into the shopping bag 200 and taken out of the shop.

In addition, in this embodiment, the information processing device 6 is disposed below the measurer 3. Therefore, according to this embodiment, the space under the measurer 3 can be effectively used as an installation space of the measurer 3.

In addition, in this embodiment, the scanner 52 is disposed above the placing part 20. In addition, a part of the placing part 20 where the bag supporting part 4 is provided is disposed in front of the scanner 52. In addition, a space 39a which is able to accept a part of the shopping bag 200 is formed between the scanner 52 and the placing part 20. Therefore, according to this embodiment, even a relatively large bag 400 or basket (for example, a basket that belongs to a customer) can be placed on the placing part 20 in the space 39a.

In addition, in this embodiment, the basket table 100 is disposed on the side of the bag supporting part 4. On the basket table 100, the shopping basket 500 which stores the articles of which the article codes are not read by the scanner 52 yet is placed. Therefore, according to this embodiment, the shopping basket 500 can be positioned on the side of the scanner 52. Here, in this embodiment, the placing surface 101a of the basket table 100 is positioned above the placing surface 20a of the measurer 3.

Here, when the article code is read by the scanner 52, the operator 700 sees the article or the reading window 52a of the scanner 52. In addition, when article information about the article of which the article code is read by the scanner 52 is displayed on the display screen 50a, the operator 700 moves his or her sight to the display screen 50a and checks the article information. Here, as a movement distance of the line of sight is reduced, a burden on the operator 700 is reduced. In this embodiment, as described above, the central portion 52c of the reading window 52a in the vertical direction is positioned closer to the lowermost end 50b of the display screen 50a from the uppermost end 4a of the bag supporting part 4 and the lowermost end 50b of the display screen 50a of the display 50. Therefore, as compared to a case where the reading window 52a is positioned closer to the uppermost end 4a of the bag supporting part 4, the movement distance of the line of sight of the operator 700 can be reduced. Therefore, according to this embodiment, the burden on the operator 700 can be reduced. Therefore, according to this embodiment, the article of which the article code is read by the scanner 52 can further be easily put into the shopping bag 200. Moreover, in this embodiment, the registration unit 72 as the display drive part displays the article information about the article of which the article code is read by the scanner 52 at the lower part of the display screen 50a. Therefore, according to this embodiment, the movement distance of the line of sight of the operator 700 can further be reduced, thereby further reducing the burden on the operator 700.

In addition, in this embodiment, the bag supporting part 4 has the pair of hook parts (the pair of the first hook parts 30 or the pair of the second hook parts 32). The pair of hook parts is pierced through the handles of the shopping bag 200 opposed at an interval. In addition, the middle position of the pair of hook parts in the opposed direction of the pair of hook parts (the pair of the first hook parts 30 or the pair of the second hook parts 32), the central portion of the display screen 50a in the opposed direction of the pair of hook parts, and the central portion of the reading window 52a in the opposed direction of the pair of hook parts are aligned on one straight line in the front view. Therefore, the movement of the line of sight of the operator 700 becomes straight between the display screen 50a, the reading window 52a, and the bag supporting part 4. Therefore, according to this embodiment, it is possible to suppress the direction of the movement of the line of sight of the operator 700 from becoming complex, so that the burden on the operator 700 can be reduced.

In addition, in this embodiment, the temporal placing table 5 is disposed in front of the scanner 52 and on the side of the scanner 52. Therefore, the operator 700 smoothly places the article of which the article code is read by the scanner 52 on the temporal placing table 5. Moreover, in this embodiment, the temporal placing table 5 is disposed below the scanner 52. Therefore, the operator 700 can place the article of which the article code is read by the scanner 52 on the temporal placing table 5 more smoothly.

### Second Embodiment

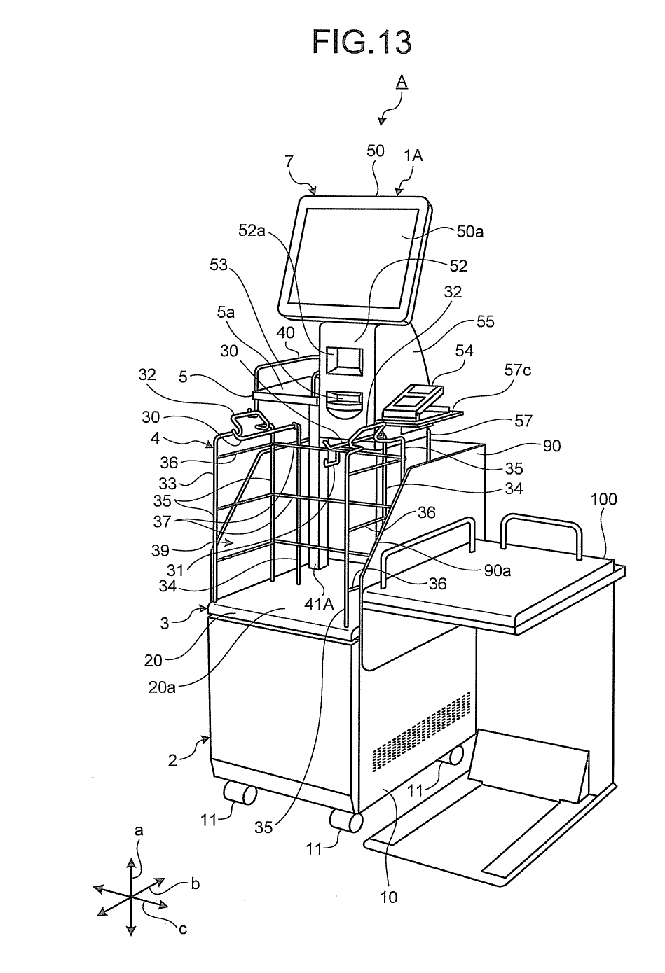

Next, a second embodiment will be described with reference to FIG. 13. In addition, like elements the same as those of the first embodiment are denoted by like reference numerals, and overlapping description will be omitted.

A bag supporting table 1A of this embodiment is different from the bag supporting table 1 of the first embodiment in that the position of the temporal placing table 5 is changed. The temporal placing table 5 of this embodiment is opposed to the user interface terminal 7 in the width direction of the corresponding device A. In addition, the temporal placing table 5 is opposed to the placing surface 20a of the placing part 20 in the vertical direction. The temporal placing table 5 is fixed to the placing surface 20a by a supporting member 41A.

In addition, the bag supporting table 1A has wheels 11 at four corners of the bottom surface of the first housing 10 in the table part 2. The bag supporting table 1A can be moved by the wheels 11. Moreover, the bag supporting table 1A has a fence member 90 positioned on the sides and the rear of the placing part 20. Upper portions of the front part of the fence member 90 are provided with chamfered portions 90a.

In the bag supporting table 1A having the above configuration, the temporal placing table 5 is opposed to the placing surface 20a of the placing part 20 in the vertical direction, so that an amount of the temporal placing table 5 protruding from the placing part 20 in the horizontal direction can be reduced.

In addition, the invention may employ various different embodiments without limiting the embodiments and departing from the spirit and scope of the invention. In each of the embodiments, the first hook part 30 and the second hook part 32 are exemplified as the bag supporting part 4. However, the embodiments are not limited thereto. For example, the bag supporting part 4 may have any of the first hook part 30 and the second hook part 32.

In addition, in each of the embodiments, the self-checkout apparatus A is exemplified as the reading apparatus. However, the embodiments are not limited thereto. An apparatus operated by a shop assistant may be used as the reading apparatus.

In addition, programs executed by the self-checkout apparatus A can be recorded on computer-readable recording media such as CD-ROMs, flexible disks (FDs), CD-Rs, and DVDs as files that can be installed or executed, so as to be provided.

In addition, the programs executed by the self-checkout apparatus A may be stored in a computer connected to a network such as Internet to be downloaded via the network so as to be provided. In addition, the programs executed the self-checkout apparatus A may be provided via a network such as Internet or distributed.

As described above, in the reading apparatus according to the embodiments, the operator can easily put the article of which the article identification information is read by the scanner into the shopping bag.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A reading apparatus comprising:
a placing part having a placing surface on which an article is placed at the upper surface;
a scanner which has a front wall provided with a reading window and reads article identification information positioned at a reading region in front of the reading window; and
a scanner holding part which disposes the scanner above the placing surface,
wherein a space is provided between the scanner and the placing part, and
the article is able to be placed on the placing part corresponding to a part below the scanner.

2. The apparatus according to claim 1, further comprising a bag supporting part which is disposed in front of the reading window and below the reading window and supports a shopping bag placed on the placing surface in an opened state.

3. The apparatus according to claim 2, further comprising a measurer measuring a load exerted on the placing part,
wherein the bag supporting part is provided on the upper surface of the placing part, and
the placing part receives a load of the shopping bag supported by the bag supporting part.

4. The apparatus according to claim 3, further comprising an information processing device which reads out a weight of an article of which article identification information is read by the scanner from a storage unit storing weights of articles, and determines whether or not an article which is not read by the scanner yet is placed on the placing part, using the read-out weight and the load measured by the measurer.

5. The apparatus according to claim 4, wherein the information processing device is disposed below the measurer.

6. The apparatus according to claim 3, wherein a part of the placing part where the bag supporting part is provided is disposed in front of the scanner.

7. The apparatus according to claim 3, further comprising a temporal placing table which is fixed to the bag supporting part and on which an article is temporarily placed.

8. The apparatus according to claim 1, further comprising a temporal placing table which is disposed on a side of the placing part in a plan view and at a position spaced from the placing part, and on which an article is temporarily placed.

9. The apparatus according to claim 8, further comprising a basket table which is disposed on the opposite side of the placing part to the temporal placing table in the plan view, and on which a shopping basket storing an article of which article identification information is not read by the scanner yet is placed.

10. The apparatus according to claim 2, further comprising a display which has a display screen disposed above the bag supporting part and displays information on the display screen,
wherein the reading window is disposed on the rear side of the bag supporting part and above the bag supporting part, and
a central portion of the reading window in a vertical direction is positioned closer to a lowermost end of the display screen from an uppermost end of the bag supporting part and the lowermost end of the display screen.

11. The apparatus according to claim 10,
wherein the bag supporting part has a pair of hook parts which are opposed to each other while being spaced in a horizontal direction and are pierced through handles of the shopping bag, and
a middle position of the pair of hook parts in an opposed direction of the pair of hook parts, a central portion of the display screen in the opposed direction, and a center portion of the reading window in the opposed direction are aligned on a straight line in a front view.

12. The apparatus according to claim 10, further comprising a display drive part for displaying article information on an article of which article identification information is read by the scanner at a lower part of the display screen.

13. The apparatus according to claim 1, further comprising a temporal placing table which is disposed in front of the scanner and on a side of the scanner and on which an article is temporarily placed.

14. The apparatus according to claim 13, wherein the temporal placing table is disposed below the scanner.
